(19) United States
(12) Patent Application Publication
(10) Pub. No.: US 2019/0254249 A1
(43) Pub. Date: Aug. 22, 2019

(54) Automatic system and apparatus for mastitis detection by means of electrical properties measurements of milk.

(71) Applicants: Alejandro Gonzalo Caamaño Fernandez, Montevideo (UY); Gabriel Nelson Caamaño Fernandez, Montevideo (UY); Santiago Enrique Caamaño Fernandez, Montevideo (UY)

(72) Inventors: Alejandro Gonzalo Caamaño Fernandez, Montevideo (UY); Gabriel Nelson Caamaño Fernandez, Montevideo (UY); Santiago Enrique Caamaño Fernandez, Montevideo (UY)

(21) Appl. No.: 16/278,218

(22) Filed: Feb. 18, 2019

Related U.S. Application Data
(60) Provisional application No. 62/631,994, filed on Feb. 19, 2018.

(51) Int. Cl. A01J 5/013; A01K 29/00

(52) U.S. Cl. CPC A01J 5/0133; A01K 29/00; A01J 5/0135; A01J 5/0136; A01J 5/0138

(57) ABSTRACT

A Health Management System for automatic monitoring of dairy animal's health. The system including a method for mastitis detection through, at least, electrical conductivity measurement of milk powered by artificial intelligence analysis. In addition, an apparatus for automatically measuring electrical conductivity and temperature of milk, and milking time length, all from each teat of the animal separately. All information is transmitted for registering and statistics development remotely.

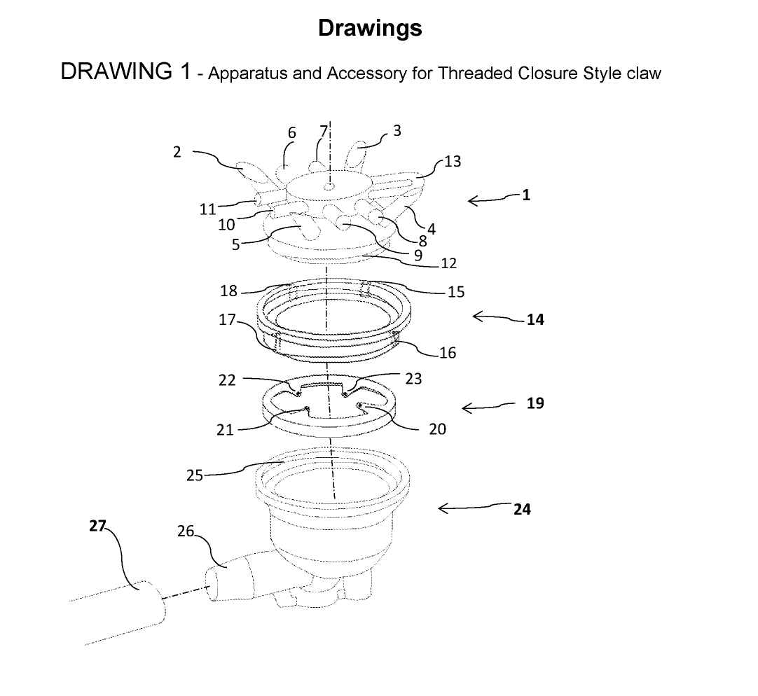

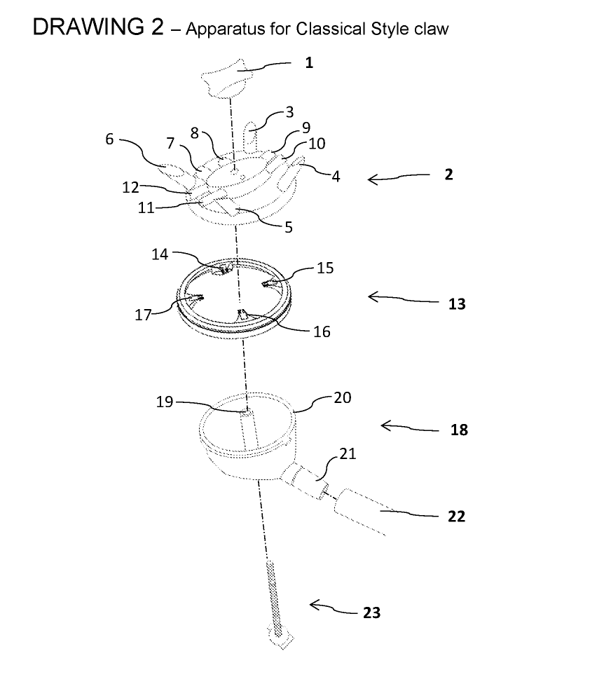

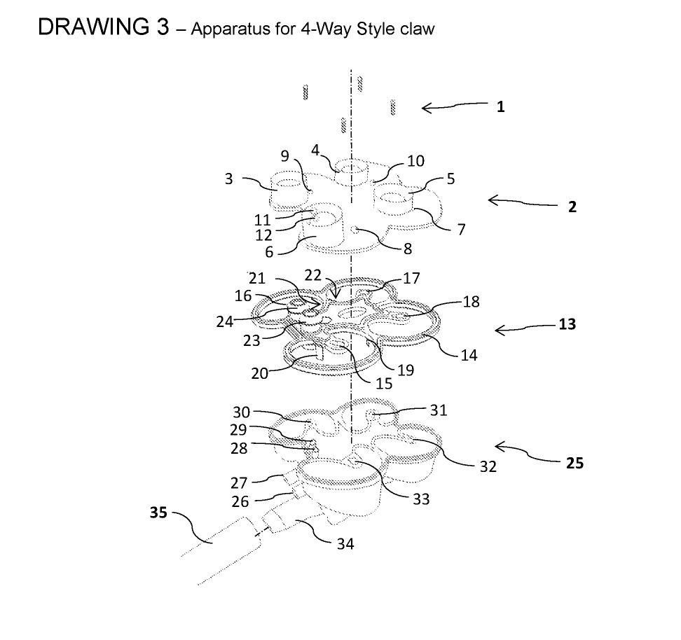

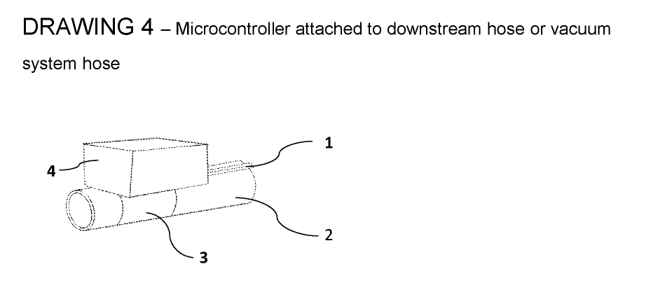

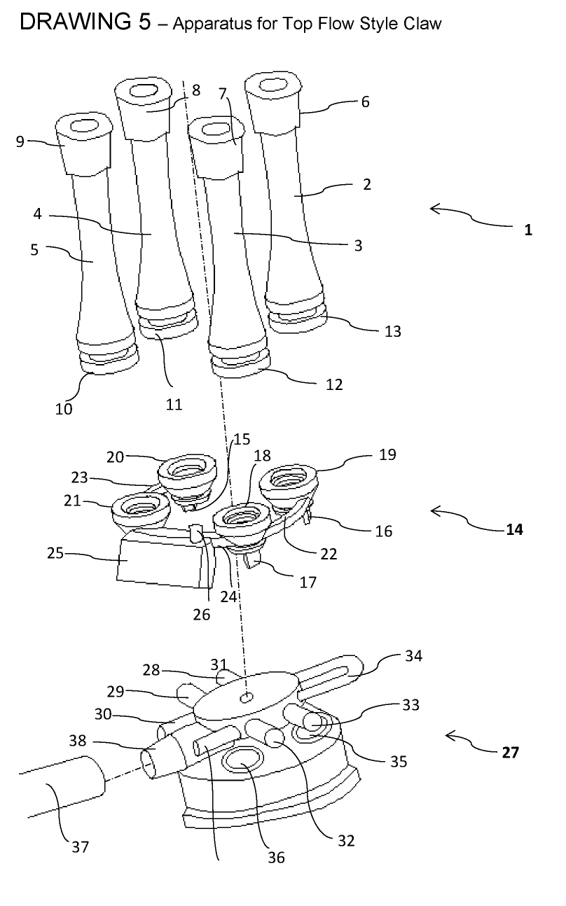

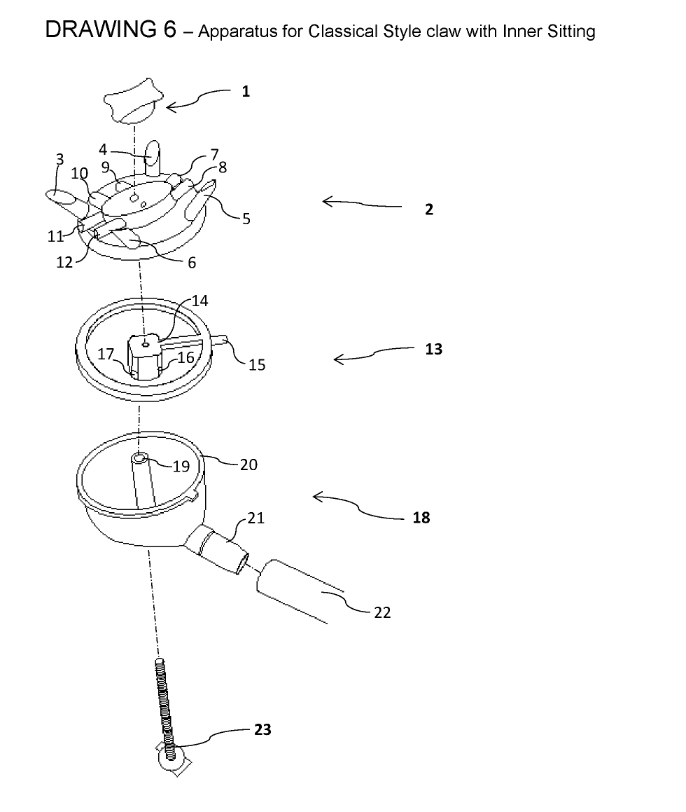

### BACKGROUND OF THE INVENTION

Dairy farming is one of the most intensive activities in countryside production. A regular dairy farm milks its animals twice a day every day of the year. This means that a standard dairy farm will have to gather all animals from wherever they are to the dairy, not missing one. Then, by groups, they must connect every animal to a set of milking parlors. After the milking is complete, the first group is released and replaced with new animals. This process takes several hours to conclude and involves substantial human labor in two shifts a day every day. Human labor can turn to be a significant part of the dairy industry costs.

Depending on the dairy farm size and profile, milking practices can vary widely. When human labor is not enough to meet all best practices' requirements, it is commonly preferred to focus on production, leaving behind important animals' health management actions and registers.

Current efforts to develop technology are focused on automating and replacing human labor. Many milking machines manufacturers have opted to focus on a completely automated milking parlor, from the animal gathering to the milking procedure. Animal health management is secondary in these new developments.

Nevertheless, health management is important from both the animal care point of view and the costs reducing point of view. Nowadays, the most spread disease among dairy animals is mastitis, being also the costliest to the industry. Mastitis is a potentially fatal mammary gland infection, most commonly observed as an inflammatory reaction of the udder tissue. It is mostly caused by bacteria and can affect the animal from several days to chronic disease suffering.

The present invention consists of a disease detection system and apparatus based on electrical measurements of every teat's raw milk separately, which can be complemented with other devices measurements. This automatic system provides a cost-effective method of reducing diseases and improving health condition of the animals. Both achieved reducing human labor, automating detection and focusing antibiotics treatments where really needed.

Clinical mastitis is the most invasive form of the disease; subclinical mastitis symptoms are not visible to the human eye and can be persistent, remaining undetected for years. The apparatus of the invention can detect early forms of clinical and subclinical mastitis. Both forms of mastitis have negative impact on milk yield and loss of milk quality, therefore causing a decrease in milk selling price. The early detection gives space to better disease treatments. Thus, the dairy can achieve shorter treatments, responsible antibiotic use, and better milk yields and properties.

### BRIEF SUMMARY OF THE INVENTION

The present invention comprises a Health Management System for automatic monitoring of dairy animal's health, including an Apparatus for milk properties measurements and a Data Analyzing Module.

The Apparatus measures, at least, an electrical property of raw milk coming from every teat of an animal. Other measurements carried by the present Apparatus are milk temperature, and milking time length. These measurements are sent to a controller which analyzes the data. The apparatus measures every milk stream automatically, and is located inside the milking cluster's claw, replacing an already existing part of it as seen in the Drawings.

The Data Analyzing Module runs an artificial intelligence method, such as logistic regression, decision trees, or neural networks, on the received data from the Apparatus. The minimum set of measurements needed for a reliable diagnosis is one electrical property measurement of each teat of the animal. Diagnosis is improved by also feeding measurements of temperature and milking time length of each teat of the animal, obtained by the present Apparatus of the present invention. All information is registered for statistics development with it. Statistics include Number of treatments carried out, Number of alerts given, Number of cows milked in the shift, etc.

### BRIEF DESCRIPTION OF THE DRAWINGS

### Drawing 1 References

### Threaded Closure Type Claw

1—Top piece of claw.
2,3,4,5—Teatcups' connections.
6,7,8,9,10,11—Vacuum system connections.
12—Male threaded side for connecting with lower piece of claw.
13—Support.
14—Accessory for apparatus fitting. Fits between the original top piece and bottom piece of the claw. Having the suitable male thread (inside and upwards) and female thread (outside and downwards) for the nipple type connection between both original pieces. This accessory having conduits (16,17,18,19) through which the cables (not represented) pass from being embedded into the apparatus to the exterior of the claw, and further connecting to the microcontroller (not represented) attached to the vacuum system hose.
15,16,17,18—Conduits through which the cables (not represented) pass.
19—Apparatus of the invention (one of the possible embodiments).
20,21,22,23—Tips towards the inside of the claw. Every tip having the electrodes of the conductivity sensors and a temperature sensor. Cables (not represented) connecting to the microcontroller are embedded into the apparatus. Every tip has the adequate length so to expose the electrodes right where each milk stream comes from the upper teatcup connections, keeping the sensors wet by milk as long as milk flows. Rounded and no-cavity shapes are preferred to avoid any substance accumulation on apparatus' rest.
24—Bottom piece of claw.
25—Threaded female connection with upper piece.
26—Connection with downstream hose.
27—Downstream hose.

### Drawing 2 References

### Pressure Closure Type Claw

1—Top closing piece—Nut containing piece for closing claw by pressure along with piece 23.
2—Top piece of claw.
3,4,5,6—Teatcups connection.
7,8,9,10,11,12—Vacuum system connection.
13—Apparatus of the invention (one of the possible embodiments).
14,15,16,17—Tips towards the inside of the claw. Every tip having the electrodes of the conductivity sensors and a temperature sensor. Cables (not represented) connecting to the microcontroller are embedded into the apparatus. Every tip has the adequate length so to expose the electrodes right where each milk stream comes from the upper teatcup connections, keeping the sensors wet by milk as long as milk flows. Rounded and no-cavity shapes are preferred to avoid any substance accumulation.
18—Bottom piece of claw,
19—Tube where piece 23 passes through all the way to piece 1.
20—Plane where sealing gasket (or apparatus) sits air-tight.
21—Connection with downstream hose.
22—Downstream hose.
23—Pressure closing piece, this bolt piece attaches to piece 1 to close the claw.

### Drawing 3 References

### Pressure Closure Type Claw

1—Closing bolts.
2—Top piece of claw.
3,4,5,6—Teatcup seat.
7,8,9,10—Holes for bolts passing through.
11,12—Holes (not seen in this view) for sealing gasket's vacuum system tubes passage.
13—Apparatus of the invention (one of the possible embodiments).
14—Squared-section shape on both sides of gasket for gasket fitting air-tight between both pieces of claw.
15,17,18—Holes for bolts passage.
16—Hole (not seen in this view) for bolt passage.
19,20—Conductivity and temperature sensors. Placed parallel to the side of the claw's wall, facing towards the downstream piece of the claw, in the middle of the milk stream path of every teat. Cables (not represented) connecting with the microcontroller are embedded into the gasket.
21,22—Conductivity and temperature sensors (not seen in this view). Placed parallel to the side of the claw's wall, facing towards the downstream piece of the claw, in the middle of the milk stream path of every teat. Cables (not represented) connecting with the microcontroller are embedded into the gasket.
23,24—Gasket's tubes acting as part of the vacuum system, with openings on both sides of gasket, and passing through the top piece of claw when assembled.
25—Bottom piece of claw.
26,27—Vacuum system connection.
28,29—Tubes part of the vacuum system.
30,31,32,33—Threaded tubes of the claw acting as nuts for the closing bolts.
34—Downstream hose connection.
35—Downstream hose.

### Drawing 4 References

### Microcontroller

1—Waterproof conduits with sensors' cables inside.
2—Milk hose, in other embodiments it can be the vacuum system's hose.
3—Tube ring for attaching microcontroller box.
4—Box containing the microcontroller of the apparatus with at least one of the walls being translucent or transparent. The microcontroller having a LED that shows results using a color-coded signal. The preferred box embodiment being waterproof and having dust protection. Other embodiments can be attached directly to the present invention apparatus and have a battery for microcontroller power supply and a wireless connection to a computer which analyzes data and returns results.

### Drawing 5 References

### Top Flow Style Apparatus

1—Teatcups.
2,3,4,5—Flexible body of each teatcup.
6,7,8,9—Teatcup's fitting place of animal's teat.
10,11,12,13—Teatcup's downstream fitting.
14—Apparatus of the invention (one of the possible embodiments).
15,16,17—Conductivity and temperature sensors placed facing towards the downstream piece of the claw, in the path of the milk stream of each teat. Cables (not represented) connecting with the microcontroller are embedded into the gasket. The number of sensors represented is 3, the remaining sensor is not seen in the present view.
18,19,20,21—Apparatus' fittings towards teatcups on the upper side, and the corresponding fitting to the claw piece in the downstream side,
22,23,24—Apparatus' arms containing the wires necessary for the corresponding sensors on each milk stream. Three of the four necessary aims are represented, the fourth one is not seen in the present view.
25—Body containing all necessary connections of sensors with the sensors' controller.
26—Cables out from apparatus to controller,
27—Claw piece of milking cluster.
28,29,30,31,32,33—Connection to vacuum system.
34—Support.
35,36—Claw's holes with fitting reinforcement for the apparatus of the present invention.
37—Downstream hose for milk.
38—Downstream hose connection.

### Drawing 6 References

### Pressure Closure Type Claw

1—Top closing piece. Nut containing piece for closing claw by pressure along with piece 23.
2—Top piece of claw.
3,4,5,6—Teatcups connection.
7,8,9,10,11,12—Vacuum system connection
13—Apparatus of the invention (one of the possible embodiments).
14—inner body of the apparatus that sits on the bottom piece of the claw. This body having an arm with the cable of the sensors embedded, connected to the microcontroller
15—Cables out from apparatus to microcontroller.
16,17—Sensors placed on the face of the inner body of the apparatus, in order to be constantly wet by milk stream of each teat of the animal. In the present view there are only two sensors represented, the remaining two sensors (not shown) are placed on the opposite faces. Cables (not represented) connecting to the microcontroller are embedded into the apparatus.
18—Bottom piece of claw.
19—Tube where piece 23 passes through all the way to piece 1.
20—Plane where sealing gasket (or apparatus) sits air-tight.
21—Connection with downstream hose.
22—Downstream hose.
23—Pressure closing piece, this bolt piece attaches to piece 1 to close the claw.

### DETAILED DESCRIPTION OF THE INVENTION

Mastitis detection through change in electrical properties in milk has been widely studied and applied by many dairy equipment manufacturers. The present invention turns the conductivity mastitis detection into a cost-effective method, measures every teat's milk properties separately and lowers the amount of false results by applying artificial intelligence analysis of data. In addition, the present invention has the capacity of emitting an overmilking alert, so as to prevent mammary tissue injury, which makes the animal prone to mastitis infection.

Every time an animal is milked, the apparatus of the invention measures the conductivity and temperature of the milk and milking time length from every teat of the animal separately. This measurement is fed in real time to the system, obtaining a result in real time. The result is an animal's health condition: normal, abnormal, ill. Alerts are delivered through a light code on the apparatus and through a display on the milking room to the workers so they can take sanitary action when needed.

The system can handle a variety of other inputs to improve its performance: animal ID, animal's milk properties history, etc. Also, the system registers all the information from milking and treatments of animal diseases.

The apparatus measures properties from every teat milk's separately. This is especially important because mastitis infection occurs one teat at a time. Measuring the milk conductivity of every teat separately lets the system analyze the most immediate change in milk properties before it is diluted in the milk coming from other teats. Having this information, the system can reduce the false-negative results to a minimum. On the other hand, false-positives are reduced by Artificial Intelligence analysis. Artificial Intelligence gives the possibility to distinguish statistically normal measurements from statistically abnormal measurements with an accuracy that absolute and previously fixed measurement ranges of ‘normal’ and ‘abnormal’ can't achieve.

The most common solution currently developed for mastitis detection using electrical properties involves measuring an electrical property of the downstream milk, at a point of the milking machines where the milk from every teat is already mixed together. Such solution certainly delivers inaccurate results because milk property changes are diluted.

Some more sophisticated apparatus can measure the electrical property from each teat separately, but they achieve this by complex means. For example, some describe a kind of trap diverting milk which modifies the normal optimum flow and requires the milking machines to be extensively modified by substituting, at least, all teatcups from the original milking machine. Other solutions require the installation of a completely modified vacuum system, alternating the milking of each teat of the animal at a time to allow only a teat's milk stream to reach a measuring sensor downstream, only after this they do allow the normal optimum vacuum system work. All these solutions need costly and structural modifications of the machines, and affect the optimum flow of milk, and therefore end up being non-cost-effective.

The system described in the current invention requires no structural modification of the milking machine, adapting the sensors into the seal of the milking machine's claw. This provides a way of obtaining the separate measurements without interfering with the optimum milk flow or vacuum system. Furthermore, the described system is reliable and cost-effective for animal health management.

All data, alerts, and registers can be accessed and are displayed through a visualization software included in the system.

Further description of both Health Management System (with the Detection module and the Data module) and Health Status Measuring Apparatus are found next.

### Health Management System

The present Health Management System can detect abnormalities in milk properties through which subclinical and clinical mastitis are diagnosed. The data entry for the Health Management System can be collected by, but is not limited to, the apparatus described in the present invention. The Health Management System contains two modules: Detection module, and Data module.

The Detection module is a data analyzing process that can be run remotely or in the microcontroller of the present described apparatus. This analysis can handle several inputs that are related to the animal's health and herd management optimization. The minimum detection input for the analysis is an electrical property measurement of the milk of the animal being milked in one of the milking stations, one measurement for each teat that is being milked. The electrical property measurement is analyzed by an artificial intelligence method (e.g.: logistic regression, decision trees, neural networks, etc.), from which three possible results are returned: normal, abnormal, ill. The result is displayed in real time with a color-coded light in the microcontroller of the Apparatus of the current invention and, if available, in a tablet, smartphone or display at the milking room. Being the case that every teat of the animal can be ill, abnormal or normal autonomously from the other teats, results given by the system correspond to one teat each. When available, other data inputs can be added, for example: milking time length of each teat, temperature of the milk of each teat, and animal identification. The apparatus described later in this invention for use with this Health Management System can provide, but is not limited to, the following outputs: conductivity measurement of milk from every teat of the animal, milking time length of each teat, and temperature of the milk of each teat. The apparatus' outputs provide enough information to have a satisfactory analysis of the health status of the animal.

The Data module provides information on both directions, feeding the microcontroller's or remote database with the collected data from other animals in the dairy farm, and receiving data from sensors and other equipment of the dairy farm such as antennas, drafting systems, and others. For example, when a suitable antenna is connected, everyday registers are stored and linked to the corresponding animal, also alerts of entering animal's health and other necessary actions can be delivered to the working staff; when a drafting system is installed, the present Health Management System alerts for action when an animal under observation is entering the milking station. All the information stored is analyzed in real time, alerts and reports are sent to the dairy farm's workers, veterinaries and other people of relevance, all of which can be modified at any time. The reports and alerts being, but not limited to, milk quality tendency, number of days under treatment, milking time length, or herd productivity ranking. Other information of relevance is asked to the dairy farm staff in an intuitive and effortless manner through the preferred communication device such as a tablet, display or smartphone when available. The asked information can be, for example, a confirmation of completion of sanitary procedures following the best practices of the industry; the oestrous status; or the start or finish of animal's treatment.

### Health Status Measuring Apparatus

The apparatus in the present invention has a plurality of conductivity and temperature sensors, one for each teat of the animal. The apparatus can be made of, but is not limited to, a flexible and resistant food-grade material, capable of acting as a sealing gasket for the claw part of a milking machine. An example of the preferred embodiment is the substitution of the center sealing gasket of the claw of a collector with a sealing gasket having the sensors embedded in it, in such way that the sensors are wet by the milk stream coming from each teat-cup before the milk streams mix downstream. The sensors are placed in such way that the impact on the flow of milk is negligible, but the sensors are constantly wet by milk during the animal's milking. The apparatus has no significant impact in the weight and balance of the whole milking machine claw. The preferred embodiments of the apparatus are the ones that do not need any modification of the structural parts of the milking machine, but only need to replace some part, for example, the center-sealing gasket (Drawings 1,2,3,5) or an attachment between the claw and the teat-cups (Drawing 6). Drawings show embodiments for the most common milking claw types, certain embodiments with threaded type closure may need an extra nipple-shaped accessory as seen in Drawing 1. Examples of the preferred embodiment are given in Drawings 1,2,3,4,5,6. The conductivity sensors' electrodes and temperature sensors are connected to a microcontroller that can be placed attached to the milk downstream hose or vacuum system hose of the collector, where it does not affect the weight or balance of the claw part, see Drawing 4. If preferred, the microcontroller can also be embedded in the apparatus body and have a battery and wireless connection to the Health Management Module. The microcontroller collects all the sensors' data and translates it as the following outputs: an electrical measurement of every teat milk stream, temperature of such milk streams, and the milking time length of every teat. All measurements along with their corresponding teat identification (e.g.: in cows “LF”, “RF”, “LH”, “RH”). The microcontroller outputs feed the previously described Health Management System, that can be run remotely or by the microcontroller itself, with or without connection to another dairy farm's equipment.

1. A Health Management System for automatic monitoring of dairy animal's health condition, the System comprising a Detection module and a Data module;
the Detection module being a data analysis comprising the steps of receiving the measurements values and data, processing the received data, and delivering the results;
receiving the measurements values and data from an apparatus with the capabilities of the present invention apparatus, being the data related to the animal's health condition or herd management,
the received data can be, but is not limited to, an electrical property measurement of each teat being milked, a temperature measurement of each teat, a time length of complete milking of the animal, a milk flow measurement, an animal identification, or any of relevance,
the minimum admitted data being an electrical property measurement of each teat being milked, or a combination of the prior stated data types that include the measurement of an electrical property of each teat, this data acting as an input for the processing step of the system;
processing of the received data through an artificial intelligence method such as logistic regression, decision trees, neural networks or any other suitable for abnormalities detection in data,
the database needed to run such artificial intelligence method being stored in the same hardware as the Detection module or being stored remotely in a source accessible by the Detection module,
the result of the processing being the animal's health condition;
the results of the data processing step delivered in real-time and displayed as a color code or any other means of communication by the hardware running the Detection module or remotely by other hardware, for example, displays, tablets, smartphones;
the Data module being a platform comprising features of Automatic Register, Manual Data Entry, Report-making, Interlinking;
the Automatic Register feature comprising the recording of information collected from the apparatus providing measurements to the Health Management System;
the Manual Data Entry being possible for certain non-automatic useful registers, being the registers, for example, oestrous cycle status, the start or finish of an animal's treatment, or the completion of sanitary procedures, manual registers being asked in an intuitive and effortless manner for the dairy staff through any device, being the preferred ways to obtain the information the prompting of relevant questions about specific animals;
the Report-making feature of the module being responsible for the report making and sending when the system's user requires one,
the reports comprising the following data, number of milked animals, number of alerts given, milk quality tendency, treatment duration, milking time length, or herd productivity ranking.

2. An apparatus for automatically measuring electrical conductivity and temperature of milk, and milking time length, all from each teat of the animal separately, the apparatus comprising:
a plurality of conductivity and temperature sensors, one of each for each teat of the animal;
the embodiment being a substitution of the center sealing gasket of the claw of a collector with a sealing gasket having the sensors embedded in said gasket, in such way that the sensors are wet by the milk stream coming from each teatcup before the milk streams mix downstream,
the sensors placed in such way that the impact on the flow of milk is negligible, but the sensors are constantly wet by milk during the animal's milking,
being the preferred embodiments of the apparatus the ones that do not need any modification of the structural parts of the milking machine, but only needing to replace some part, for example, the center-sealing gasket or an attachment between the claw and the teat-cups,
such apparatus embodiments are shown in the present invention Drawings for common claw styles, and certain embodiments needing an extra nipple-shaped accessory to fit between the apparatus and the claw,
such apparatus' illustrations found in Drawings 1, 2,3,5 and 6;
a microcontroller that collects all the sensors' data and translates it as the following outputs: an electrical property measurement of every teat milk stream, temperature of such milk streams, and the milking time length of every teat,
all measurements along with its corresponding teat identification (e.g.: in cows “LF”, “RF”, “LH”, “RH”), an example of a possible embodiment can be seen in Drawing 4, the embodiment comprising a box containing the microcontroller of the apparatus, with at least one of the walls being translucent or transparent, the microcontroller having a LED light through which communicate using a color-coded signal, being the preferred box embodiment waterproof and dustproof.

3. A System comprising claims 1 and 2.
